(19) United States
(12) Patent Application Publication
(10) Pub. No.: US 2024/0196890 A1
(43) Pub. Date: Jun. 20, 2024

(54) HERBICIDAL MIXTURES AND COMPOSITIONS AND METHODS OF USE

(71) Applicant: SBM DÉVELOPPEMENT SAS, Ecully (FR)

(72) Inventors: Thomas Eli MACOM, Holly Springs, NC (US); Robert Britt BAKER, Cary, NC (US); Gary Eugene GORE, Four Oaks, NC (US)

(21) Appl. No.: 18/279,410

(22) PCT Filed: Mar. 1, 2022
(86) PCT No.: PCT/US2022/018242

§ 371 Date: Aug. 30, 2023

Related U.S. Application Data
(60) Provisional application No. 63/154,915, filed on Mar. 1, 2021.

(51) Int. Cl. A01N 37/02; A01N 65/28; A01P 13/00

(52) U.S. Cl. CPC A01N 37/02; A01N 65/28; A01P 13/00

(57) ABSTRACT

The invention relates to herbicidal mixtures and compositions comprising an acid and/or a salt and/or an ester of an acid, and an essential oil, wherein the acid is a fatty acid and/or an organic acid, and methods of using the same for controlling plant growth.

### FIELD OF THE INVENTION

The invention relates to herbicidal mixtures and compositions comprising an acid and/or a salt and/or an ester of an acid, and an essential oil, wherein the acid is a fatty acid and/or an organic acid, and methods of using the same for controlling plant growth.

### BACKGROUND OF THE INVENTION

Herbicides containing fatty acids and organic acids are used for the control of weeds. However, there is a need to reduce the amounts of these compounds present in standard herbicidal mixtures while retaining the same or increasing the efficacy in controlling plant growth, e.g., weeds. The present invention addresses these needs by providing a novel formulation using one or more fatty acids and/or acetic acid in combination with essential oils, which provides weed control as the same or at an increased level compared to standard herbicidal mixtures using fatty acids and/or organic acids (and/or their salts and/or esters) without essential oils.

### SUMMARY OF THE INVENTION

A first aspect of the invention provides an herbicidal mixture comprising: an acid and/or a salt and/or an ester of an acid; and an essential oil, wherein the acid is a fatty acid and/or an organic acid.

A second aspect of the invention provides a method of controlling plant growth comprising contacting a plant, plant part and/or a plant environment with an effective amount of an herbicidal mixture of the present invention.

These and other aspects of the invention are set forth in more detail in the description of the invention below.

### BRIEF DESCRIPTION OF THE DRAWINGS

FIG. 1 shows the results of a field trial comparing the control of Oxalis stricta with the New formulation of 1RBB129-1 (fatty acid at 2.75% and clove oil at 0.5% active ingredient (ai)/v, Natria Grass and Weed (3.68% fatty acid ai/v) and Natria G&W Killer+Root Kill (3.68% fatty acid+0.5% maleic acid ai/v).

FIG. 2 shows the results of a field trial comparing the control of Dichondra repens with the New formulation of 1RBB129-1 (fatty acid at 2.75% and clove at 0.5% ai/v), Natria Grass and Weed (3.68% fatty acid ai/v) and Natria G&W Killer+Root Kill (3.68% fatty acid+0.5% maleic acid ai/v). Y axis shows % control.

FIG. 3 shows the results of a field trial comparing the control of Oenothera laciniata to several formulations of fatty acid (Natria Grass and Weed 3.68% fatty acid ai/v, Natria G&W Killer+RT 3.68% fatty acid+0.5% maleic acid ai/v and 1RBB129-1 (2.75% fatty acid+0.5% clove oil ai/v).

FIG. 4 shows the results of a field trial comparing the control of Paspalum saurae to several formulations of fatty acid (Natria Grass and Weed 3.68% fatty acid ai/v, Natria G&W Killer+RT 3.68% fatty acid+0.5% maleic acid ai/v and 1RBB129-1 (2.75% fatty acid+0.5% clove oil ai/v).

FIG. 5 shows the results of a field trial comparing the control of Eremochloa ophiuroides to several formulations of fatty acid (Natria Grass and Weed 3.68% fatty acid ai/v, Natria G&W Killer+RT 3.68% fatty acid+0.5% maleic acid ai/v and 1RBB129-1 (2.75% fatty acid+0.5% clove oil ai/v).

FIG. 6 shows the results of a greenhouse trial comparing dandelion regrowth after an application of various natural oils.

FIG. 7 shows the results of a field trial comparing the control of black medic to several formulations of fatty acid.

### DETAILED DESCRIPTION

The present invention now will be described hereinafter with reference to the accompanying drawings and examples, in which embodiments of the invention are shown. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. Thus, the invention contemplates that in some embodiments of the invention, any feature or combination of features set forth herein can be excluded or omitted. In addition, numerous variations and additions to the various embodiments suggested herein will be apparent to those skilled in the art in light of the instant disclosure, which do not depart from the instant invention. Hence, the following descriptions are intended to illustrate some particular embodiments of the invention, and not to exhaustively specify all permutations, combinations and variations thereof.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

All publications, patent applications, patents and other references cited herein are incorporated by reference in their entireties for the teachings relevant to the sentence and/or paragraph in which the reference is presented.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The term “about,” as used herein when referring to a measurable value such as an amount or concentration and the like, is meant to encompass variations of ±10%, ±5%, 1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X.

A range provided herein for a measurable value may include any other range and/or individual value therein. Thus, a recitation of ranges of values herein are merely intended to serve as a shorthand method of referring individually to each separate value falling within the range, unless otherwise indicated herein, and each separate value is incorporated into the specification as if it were individually recited herein. For example, if the range 10 to 15 is disclosed, then 11, 12, 13, and 14 are also disclosed, as well as the ranges of 10 to 13, 11 to 14, etc.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 5%, 10%, 15%, 20%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 5%, 10%, 15%, 20%, 25%, 35%, 50%, 75%, 80%, 85%, 90%, 95%, 97%, 98%, 99%, or 100% as compared to a control.

“Alkyl” as used herein alone or as part of another group, refers to a straight or branched chain hydrocarbon containing from 1 to 20 carbon atoms, 1 to 10 carbons, or 1 to 6 carbons, which can be referred to as a C1-C20 alkyl, C1-C10 alkyl or C1-C6 alkyl. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. “Loweralkyl” as used herein, is a subset of alkyl, and, in some embodiments, refers to a straight or branched chain hydrocarbon group containing from 1 to 4 carbon atoms. Representative examples of loweralkyl include, but are not limited to, methyl, ethyl, n-propyl, iso-propyl, n-butyl, iso-butyl, tert-butyl, and the like. The term “alkyl” or “loweralkyl” is intended to include both substituted and unsubstituted alkyl or loweralkyl unless otherwise indicated and these groups may be substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), alkenyloxy, alkynyloxy, haloalkoxy, cycloalkoxy, cycloalkylalkyloxy, aryloxy, arylalkyloxy, heterocyclooxy, heterocycloalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, carboxy, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Alkoxy” as used herein alone or as part of another group, refers to an alkyl or loweralkyl group, as defined herein (and thus including substituted versions such as polyalkoxy), appended to the parent molecular moiety through an oxy group, —O—. Representative examples of alkoxy include, but are not limited to, methoxy, ethoxy, propoxy, 2-propoxy, butoxy, tert-butoxy, pentyloxy, hexyloxy and the like.

“Alkoxyalkyl” as used herein alone or as part of another group, refers to an alkyl or loweralkyl group, as defined herein (and thus including substituted versions such as polyalkoxy), appended to another alkyl or loweralkyl group through an oxy group, —O—, such as, but not limited to, —CH₂CH₂OCH₂CH₂CH₃.

As used herein, the term “plant part” refers to at least a fragment of a whole plant. Mixtures and compositions of the present invention may be applied to or contacted with any suitable plant part, including, but not limited to, anthers, branches, buds, calli, clumps, cobs, cotyledons, ears, embryos, filaments, flowers, fruits, husks, kernels, leaves, lodicules, ovaries, palea, panicles, pedicels, pods, pollen, protoplasts, roots, root tips, seeds, silks, stalks, stems, stigma, styles, and tassels.

As used herein, a “plant environment” is any area where a plant or plant part may be found, and for which control of the plant or plant part is desirable. Non-limiting examples of a plant environment may include soil or a substrate (synthetic or natural) in which a plant or plant part may be found. A “plant environment” can include, but is not limited to, a residential yard, a landscaped area, a flower garden, a sidewalk, a driveway, a street or road, a trail, a building or other structure (on which a plant may grow), a fence, trees, shrubs, a vacant lot, a wooded lot, a field, a plot, a plot under preparation as a garden or for crops.

As used herein, “control of growth” means reducing the growth of a plant or a plant part and can include death of the plant or plant part. Control of growth may include, but is not limited to, reducing growth of a plant or plant part over time, and/or producing observable plant and/or plant part phytotoxicity, and/or a more rapid observable phytotoxicity to the plant and/or plant part. As used herein, control of growth with the herbicidal mixtures of the invention is as compared to a control (e.g., an herbicidal mixture comprising fatty acid and/or organic acid but without essential oil; see, e.g., Finalsan Weed and Grass (ammoniated soap of fatty acids (22% w/w)), Finalsan Plus Weed and Grass Killer (18.52% w/v pelargonic acid and 30 g/l (2.98% w/v) maleic hydrazide), SCYTHE (57% by wt pelargonic acid (Nonanoate) and related fatty acids (3% by wt), Axxe BIO Safe (ammonium nonanoate, 40% by % w/w), Mirimichi Green PRO Weed Control (ammonium nonanoate, 40 wt. %), Earth-Tone® 4 in 1 Weed Control (3.68% ammoniated soap of fatty acids and 0.5% maleic hydrazide, Natria™ Grass & Weed Killer (3.68% ammoniated soap of fatty acids and 0.5% maleic hydrazide)). A standard herbicidal mixtures for comparison to an organic acid mixture of this invention includes, but is not limited to, acetic acid, wherein the control comprises the acetic acid without any essential oil.

As used herein, the term “observable phytotoxicity” refers to observable phenotypes of decline of a plant and/or plant part, following contact with a mixture or composition of the present invention, and includes, but is not limited to, such phenotypic characteristics as dehydration, wilting, leaf curling, discoloration (e.g., chlorosis, browning, and the like), and necrosis. “Discoloration” may include any change in color from the natural color of the tissue prior to application of a composition or mixture of the invention. Thus, discoloration can include, but is not limited to, yellowing (e.g., chlorosis) and browning. A phenotype can be observable to the naked eye, or by any other means of evaluation known in the art, e.g., microscopy, biochemical analysis, or an electromechanical assay (e.g., HPLC, GC, LCMS, and the like).

As used herein, the term “residual control” is defined as control of regrowth/re-emergence and/or plant migration (by runners, roots, seeds or other plant propagules (e.g., stolons, tubers, rhizomes and/or bulbs and the like, i.e., any structure from which a plant can arise and grow into treatment area from outside of treatment area.

The present inventors have surprisingly discovered that the amount of an acid (e.g., at least one fatty acid, at least one organic acid, or a mixture of at least one fatty acid and at least one organic acid) in an herbicidal mixture may be reduced by at least about 25% to about 80% when the herbicidal mixture also comprises an essential oil (e.g., at least one essential oil) in combination with the acid, wherein the herbicidal mixture comprising the acid and essential oil achieves the same or increased efficacy over standard mixtures comprising acids (e.g., fatty acids and/or organic acids (and salts and/or esters thereof) not comprising an essential oil). This reduction in the amount of acid in an herbicide mixture is advantageous at least for the reason that the costs for production of an herbicide comprising a fatty acid and/or organic acid that is effective are reduced.

In some embodiments, the herbicidal effect that is observed includes but is not limited to, for example, control or increased control of growth of a plant and/or plant part; control or increased control of growth of a plant and/or plant part over time; increased rate of observable plant and/or plant part phytotoxicity; reduced time to observable phytotoxicity; increased residual control of a plant and/or plant part as compared to a control (e.g., a plant, plant part and/or plant environment contacted with an herbicidal mixture comprising fatty acids, organic acids, or mixtures of fatty acids and organic acids at the standard amounts or rates for standard herbicidal mixtures that do not comprise essential oils; or a plant, plant part and/or plant environment contacted with an herbicidal mixture comprising the same amount of acid present in the herbicidal mixtures of the invention but in the absence of an essential oil).

In some embodiments, the present invention provides an herbicidal mixture comprising, consisting essentially of, or consisting of at least one acid and/or an ester and/or salt thereof and at least one essential oil, wherein the at least one acid is a fatty acid and/or an organic acid.

Fatty acids useful for mixtures and compositions of the invention may be any form of fatty acid known in the art for use in an herbicidal formulation. In some embodiments, the fatty acid is a saturated fatty acid. In some embodiments, the fatty acid is a saturated fatty acid comprising the formula of CH₃(CH₂)nCOOH, wherein n=6-8. In some embodiments, a saturated fatty acid is a C₈ fatty acid (caprylic acid (octanoic acid)), a C₉ fatty acid (pelargonic acid (nonanoic acid)), and/or a C₁₀ fatty acid (capric acid (decanoic acid)).

A non-limiting example of a structure of octanoic acid is:

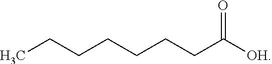

A non-limiting example of a structure of nonanoic acid is:

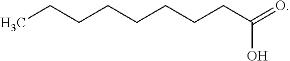

A non-limiting example of a structure of decanoic acid is:

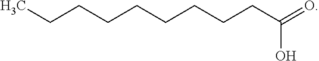

A salt of a fatty acid includes, but is not limited to, an ammonium salt, a potassium salt, a choline salt, and/or a sodium salt.

An ester of a fatty acid includes, but is not limited to, 2-ethyhexyl, 2-butoxy, and/or butoxyethyl.

In some embodiments, an herbicidal mixture of the invention may comprise a C₈ fatty acid, a C₉ fatty acid, a C₁₀ fatty acid or any combination thereof. In some embodiments, the herbicidal mixture comprises only C₈ fatty acid. In some embodiments, the herbicidal mixture comprises only C₉ fatty acid. In some embodiments, the herbicidal mixture comprises only C₁₀ fatty acid. In some embodiments, the herbicidal mixture comprises C₈ fatty acid and C₉ fatty acid. In some embodiments, the herbicidal mixture comprises C₈ fatty acid and C₁₀ fatty acid. In some embodiments, the herbicidal mixture comprises C₉ fatty acid and C₁₀ fatty acid. In some embodiments, the herbicidal mixture comprises C₈ fatty acid, C₉ fatty acid and C₁₀ fatty acid.

Organic acids useful for mixtures and compositions of the invention may be any form of organic acid known in the art for use in an herbicidal formulation. In some embodiments, the organic acid comprises the formula of C₂H₂ₙO₂. In some embodiments, the organic acid is formic acid, acetic acid, propionic acid, butyric acid (butanoic acid), valeric acid (pentanoic acid), hexanoic acid (caproic acid), heptanoic acid, octanoic acid (caprylic acid), and/or nonanoic acid.

A non-limiting example of a structure of formic acid is:

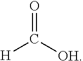

A non-limiting example of a structure of acetic acid is:

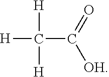

A non-limiting example of a structure of propionic acid is:

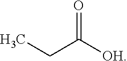

A non-limiting example of a structure of butyric acid is:

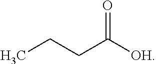

A non-limiting example of a structure of valeric acid (pentanoic acid) is:

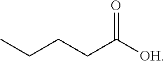

A non-limiting example of a structure of hexanoic acid (caproic acid) is:

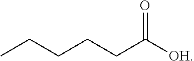

A non-limiting example of a structure of octanoic acid (caprylic acid) is:

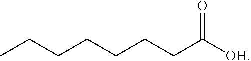

A non-limiting example of a structure of nonanoic acid (acid) is:

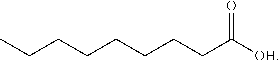

In some embodiments, an essential oil useful with an herbicidal mixture of the invention can include, but is not limited to, eugenol (i.e., oil of clove), manuka oil, wormwood oil, cinnamon oil, nutmeg oil, basil oil, Japanese star anise oil, lemon balm oil, dill oil, pimenta racemose oil, vanilla oil, bay laurel oil, celery oil, ginger oil, and/or wood avens oil. In some embodiments, the essential oil is eugenol and/or manuka oil. In some embodiments, the essential oil is eugenol. Is some embodiments, the source of eugenol may be clove, wormwood oil, cinnamon oil, nutmeg oil, basil oil, Japanese star anise oil, lemon balm oil, dill oil, pimenta racemose oil, vanilla oil, bay laurel oil, celery oil, ginger oil, wood avens oil, or any combination thereof. In some embodiments, eugenol may be obtained from allspice, bay rum, greater galangal, basil, nutmeg, turmeric, bay leaf, hyssop, oregano, marjoram, and many other culinary and medicinal plants. In some embodiments, eugenol may be obtained from Syzygium aromaticum, in which there are three types of oil, bud oil, leaf oil and stem oil. Bud oil comprises about 60-90% eugenol, leaf oil comprises about 82-88% eugenol and stem oil comprises about 90-95% eugenol.

A non-limiting example of a structure of eugenol is:

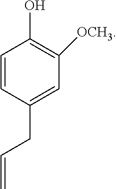

Manuka oil is obtained from Leptospermum scoparium (e.g., tea tree; tea tree oil). The composition of manuka oil is complex (Douglas et al. Phytochemistry 65:1255-1264 (2004)). Three major groups of compounds have been identified in manuka oils: monoterpenes, sequiterpenes and triketones (Crop & Food Research Broadsheet. Essential Oil Production from Manuka and Kanuka. Number 116 July 2000).

In some embodiments, an herbicidal mixture of the invention comprises a fatty acid in an amount of about 1.25% weight/volume (w/v) to about 3% w/v of the mixture and/or composition, e.g., about 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, or 3% w/v, or any range or value therein. In some embodiments, the fatty acid is present in an amount of about 1.25% w/v to about 3% w/v (e.g., about 1.25, 1.5, 1.75, 2, 2.25, 2.5, 2.75, or 3% w/v or any value or range therein) or about 2% w/v to about 3% w/v (e.g., about 2, 2.25, 2.5, 2.75, or 3% w/v, or any range or value therein) of the herbicidal mixture. In some embodiments, the fatty acid is present in an amount of about 2.75% w/v.

In some embodiments, an herbicidal mixture and/or composition of the invention comprises an essential oil in an amount of about 0.1% weight/volume (w/v) to about 8% w/v of the mixture and/or composition, e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8% w/v, or any range or value therein. In some embodiments, the amount of an essential oil in an herbicidal mixture may be about 0.1%, 0.2%, 0.3%, 0.4%, 0.5%, 0.6%, 0.7%, 0.8%, 0.9% w/v to about 1%, 2%, 3%, 4%, 5% w/v. In some embodiments, the amount of essential oil in the herbicidal mixture may be about 0.5% w/v.

In some embodiments, an herbicidal mixture comprises a fatty acid (e.g., one or more fatty acids) in an amount of about 2.75% w/v and an essential oil (e.g., at least one essential oil) in an amount of about 0.5% w/v.

While not wishing to be bound by any particular theory, it is believed that the essential oil of this novel herbicidal mixture comprising and acid (e.g., a fatty acid and/or organic acid) and an essential oil provides more efficient penetration of the leaf surface by the fatty acid active ingredient. The more efficient penetration, believed to be an effect of the essential oil, allows the use of a reduced amount of fatty acid in the herbicidal mixture, while at the same time maintaining the same or increasing the herbicidal effect or efficacy of the herbicidal mixture over standard herbicides comprising fatty acids.

An herbicidal mixture and/or composition of the invention may be provided in any formulation useful for application to/contact with a plant, plant part, and/or a plant environment (e.g., an area where the plant is present, e.g., a plant substrate (synthetic or natural), e.g., a soil) for control of plant growth (e.g., weed control). In some embodiments, an herbicidal mixture and/or composition may be in the form of a liquid or a solid (e.g., a spray, an aqueous solution, a non-aqueous solution, a suspension, an emulsion (e.g., in oil (vegetable or mineral)), a flowable mixture, a slurry, a powder, a particle, a granule, a mist, an aerosol, a foam, and/or any combination thereof.

In some embodiments, an herbicidal mixture and/or composition of the invention may be provided in a “ready-to-use” formulation and/or in a concentrated formulation to be diluted prior to application to a plant, plant part, and/or plant environment. In some embodiments, a concentrated formulation of a mixture or composition of the invention may comprise acid in an amount in a range of about 10% to about 25% w/v of the mixture and/or composition, e.g., about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5 or 25% % w/v, or any range or value therein, of the mixture and/or composition. Thus, in some embodiments, the amount of acid in a concentrated formulation may be in a range of about 15% to about 25% w/v, about 20% to about 23% w/v, or about 20% to about 25% w/v, or any range or value therein, of the mixture and/or composition. In some embodiments, the amount of acid in a concentrated formulation may be about 20, 21, 22, 23, or 25% w/v or any range or value therein of the mixture and/or composition, optionally about 22% w/v.

In some embodiments, a concentrated formulation of a mixture and/or composition of the invention may comprise an essential oil in an amount in a range of about 1% to about 15% w/v of the mixture and/or composition, e.g., about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15% w/v, or any range or value therein, of the mixture and/or composition. Thus, in some embodiments, the amount of an essential oil in a concentrated formulation may be in a range of about 3% to about 5%, about 3% to about 6%, about 3% to about 7%, or about 3% to about 8% w/v, or any range or value therein, of the mixture and/or composition. In some embodiments, the amount of essential oil in a concentrated formulation may be about 3, 4, 5, or 6% w/v or any range or value therein of the mixture and/or composition, optionally about 4% w/v.

In some embodiments, a concentrated formulation of a mixture and/or composition of the invention may comprise an acid in an amount of about 15-25% w/v, or any range or value therein, of the mixture and/or composition, optionally about 22% w/v of the mixture and/or composition, and an essential oil in an amount of about 3-6% w/v, or any range or value therein, of the mixture and/or composition, optionally about 4% w/v of the mixture and/or composition.

A ready-to-use (RTU) formulation of an herbicidal mixture and/or composition of the invention does not require further dilution before it may be applied to a plant, plant part and/or plant environment. A ready-to-use formulation may be prepared by diluting a concentrated formulation of a mixture or composition of the invention. For example, a concentrate of the herbicidal mixture and/or composition of the invention is diluted 1.5 oz in 1 gallon (128 oz)—a dilution of at least about 80, 81, 82, 83, 84, 85, 86, 87 fold, optionally a dilution of about 85.33 fold or about 85 fold.

In some embodiments, a ready-to-use formulation of an herbicidal mixture and/or composition may comprise an acid (e.g., at least one fatty acid, at least one organic acid, or a mixture of at least one fatty acid and at least one organic acid) in an amount in the range of about 1% weight/volume (w/v) to about 4% w/v of the mixture and/or composition, e.g., about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9 or 4% w/v, or any range or value therein of the mixture or composition. In some embodiments, a ready-to-use formulation of an herbicidal mixture and/or composition may comprise an acid in an amount in the range of about 1.25% to about 3% w/v or any range or value therein, of the mixture and/or composition (e.g., about 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, or 3% w/v or any range of value therein). Thus, in some embodiments, the amount of a fatty acid in a mixture and/or composition that is a ready-to-use formulation may be in a range of about 2.5%-3% w/v, optionally about 2.6%-2.8% w/v, (e.g., about 2.65, 2.7, 2.75, or 2.8 w/v) or may be in an amount of about 2.75% w/v.

In some embodiments, a ready-to-use formulation of an herbicidal mixture and/or composition may comprise an essential oil (e.g., eugenol and/or manuka oil) in an amount in the range of about 0.1% w/v to about 8% w/v or any range or value therein, of the mixture and/or composition, e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8% w/v, or any range or value of the mixture and/or composition. In some embodiments, a ready-to-use formulation of an herbicidal mixture and/or composition may comprise an essential oil in an amount in the range of about 0.1% to about 1%, about 0.1% to about 2%, 0.1% to about 3%, about 0.1% to about 4%, about 0.1% to about 5%, about 0.1% to about 6% w/v or any range or value therein, of the mixture and/or composition. In some embodiments, the herbicidal mixture as a ready to use formulation may comprise an amount of essential oil in the range of about 0.1% to about 2% w/v (e.g., about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2% w/v or any range or value therein), optionally in the range of about 0.2 to about 1% w/v, about 0.2% to about 0.8% w/v, about 0.3% to about 0.6% w/v, or an amount of essential oil about 0.5% w/v.

In some embodiments, a ready-to-use formulation of an herbicidal mixture and/or composition may comprise an acid (e.g., at least one fatty acid, at least one organic acid, or a mixture of at least one fatty acid and at least one organic acid) and an essential oil in a ratio of about 0.15 to about 30 (0.15, 0.2, 0.25, 0.3, 0.35, 0.4, 0.45, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, or 30, or any range or value therein), optionally a ratio of about 1 to about 10, or about 4 to about 6, optionally in a ratio of about 5.5.

The herbicidal mixtures of the present invention comprising an acid (e.g., one or more C₈-C₁₀ fatty acids, one or more organic acids (CH₃(CH₂)nCOOH, wherein n=6-8), or a mixture of one or more organic acids and one or more fatty acids) and/or a salt and/or ester of the acid and an essential oil (e.g., eugenol and/or manuka oil) provide the advantage of achieving the same herbicidal effect or an increased herbicidal effect as compared to standard herbicidal mixtures comprising an acid but not comprising an essential oil. This effect is surprising and could not have been predicted from what was known about fatty acids or essential oils prior to the disclosure of the present invention. In some embodiments, the amount of acid in the herbicidal mixtures of the present invention may comprise the same amount or may comprise a lower amount of acid compared to a standard herbicidal mixture (e.g., at least about 25% to about 80% (e.g., about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80%) less than the amount of the acid in standard herbicidal mixtures (e.g., an herbicidal mixture comprising acid and no essential oil; see, e.g., Finalsan Weed and Grass (ammoniated soap of fatty acids (22% wt/wt)), Finalsan Plus Weed and Grass Killer (18.52% w/v pelargonic acid and 30 g/l (2.98% w/v) maleic hydrazide), SCYTHE (57% by wt pelargonic acid (Nonanoate) and related fatty acids (3% by wt), Axxe BIO Safe (ammonium nonanoate, 40% wt/wt), Mirimichi Green PRO Weed Control (ammonium nonanoate, 40.0 wt. %), Earth-Tone® 4 in 1 Weed Control (3.68% ammoniated soap of fatty acids and 0.5% maleic hydrazide, Natria™ Grass & Weed Killer (3.68% ammoniated soap of fatty acids and 0.5% maleic hydrazide). Thus, in some embodiments, the amount of acid in an herbicidal mixture of the invention may be about 20-80% less than the amount of fatty acid in a standard herbicidal mixture/formulation.

In some embodiments, the herbicidal mixtures of the present invention comprising an acid (e.g., one or more C₈-C₁₀ fatty acids, one or more organic acids (CH₃(CH₂)nCOOH, wherein n=6-8), or a mixture of one or more organic acids and one or more fatty acids) and/or a salt and/or ester of the acid and an essential oil (e.g., eugenol and/or manuka oil) provide the advantage of achieving the same herbicidal effect or an increased herbicidal effect as compared to standard herbicidal mixtures comprising an acid and no essential oil.

An “increased herbicidal effect” as used herein refers to an increase in control of weeds (e.g., control of plant growth), optionally increase in control over a longer period of time (e.g., increased residual control) as compared to standard herbicides that comprise at least one acid but no essential oil. In some embodiments, control may be for 14, 15, 16, 17, 18, 19, 20, 21, 22, 23, 24 days.

An herbicidal mixture of the present invention may further comprise additional active ingredients in an amount in the range of about 0.02% to about 25% w/v (e.g., about 0.02, 0.03, 0.04, 0.05, 0.10, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5 or 25% w/v). In some embodiments, the active ingredient is a pre-emergent herbicide or a post-emergent herbicide. A post emergent herbicide useful with the invention may include, but is not limited to, a post-emergent broadleaf herbicide, a post-emergent crabgrass herbicide and/or a post-emergent grass herbicide. A pre-emergent herbicide useful with the invention may include, but is not limited to, atrazine, benefin, bensulide, DCPA, dimethenamid, ethofumesate, florasulam, flumioxazin, indaziflam, isoxaben, metolachlor, oryzalin, oxadiazon, pendimethalin, prodiamine, pronamide, siduron, maleic hydrazide, and/or simazine. Non-limiting examples of post-emergent broadleaf herbicides useful with the invention include 2,4-DP, amicarbazone, atrazine, bentazon, bispyribac-sodium, bromoxynil, carfentrazone, chlorsulfuron, clopyralid, ethofumesate, flazasulfuron, florasulam, fluroxypyr, glyphosate, halosulfuron, imazapic, imazaquin, imazasulfuron, MCPA, mesitrione, metribuzin, metsulfuron, MSMA, penoxsulam, pyraflufen-ethyl, quinclorac, quinclorac, simazine, sulfentrazone, sulfosulfuron, thiencarbacone, thiencarbazone, topramezone, triclopyr, maleic hydrazide, and/or trifloxysulfuron.

Post-emergent crabgrass herbicides useful with the herbicide mixtures of the invention include but are not limited to, atrazine, auslam, bispyribac-sodium, fenoxaprop, fluorasulam, MSMA, quinclorac, maleic hydrazide, and/or simazine. Non-limiting example post-emergent grass herbicides useful with the invention include bentazon, carfentrazone, chlorsulfuron, clethodim, diflufenzopyr, diquat, fenoxaprop, flazasulfuron, fluazifop, fluoxapyr, foramsulfuron, glufosinate, glyphosate, halosulfuron, imazapyr, imazaquin, imazapic, imazethapyr, indaziflam, iodosulfuron, mesotrione, metribuzin, metsulfuron, MSMA, paraquat, pronamide, quinclorac, risulfuron, sethoxydim, sulfentrazone, topramezone, maleic hydrazide, and/or trilopyr. In some embodiments, the additional active ingredient is not glyphosate. In some embodiments, the additional active ingredient is not diquat.

The present invention further provides methods of using the herbicidal mixtures or composition(s) of the present invention.

In some embodiments, the present invention provides a method of controlling plant growth comprising contacting a plant, plant part, and/or a plant environment with an effective amount of an herbicidal mixture of the present invention as described herein. In some embodiments, the present invention provides a method of controlling plant growth comprising contacting a plant, plant part, and/or a plant environment with an effective amount of a composition comprising, consisting essentially of, or consisting of an acid and/or an ester and/or salt thereof (e.g., one or more C₈-C₁₀ fatty acids, one or more organic acids (CH₃(CH₂)nCOOH, wherein n=6-8), or a mixture of one or more organic acids and one or more fatty acids) and an essential oil (e.g., eugenol and/or manuka oil). In some embodiments, the herbicidal mixture (e.g., an effective amount of the herbicidal mixture) achieves the same or an increased herbicidal effect using a lower amount of acid (e.g., a lower amount of C₈ fatty acids, C₉ fatty acids, C₁₀ fatty acids and/or organic acids and/or salts and/or esters thereof) as compared to a standard herbicide comprising an acid (e.g., C₈-C₁₀ fatty acids, organic acids (CH₃(CH₂)nCOOH, wherein n=6-8), or a mixture of one or more organic acids and one or more fatty acids) but no essential oil (e.g., no eugenol and no manuka oil).

In some embodiments, an herbicidal mixture of the invention for controlling plant growth and comprising at least one acid and at least one essential oil comprises the same amount of acid (e.g., C₈-C₁₀ fatty acids, organic acids (CH₃(CH₂)nCOOH, wherein n=6-8), or a mixture of fatty acids and organic acids) as in a standard herbicidal composition that comprises acid but no essential oil (e.g., no eugenol oil and/or manuka oil). In some embodiments, an herbicidal mixture for controlling plant growth and comprising at least one acid and at least one essential oil comprises at least about 25% to about 80% less acid than the amount in a standard herbicide comprising acid and no essential oil (e.g., no eugenol oil and/or manuka oil).

In some embodiments, the present invention provides a method of controlling undesirable plant growth comprising contacting an undesired plant and/or plant part thereof, and/or a plant environment with an effective amount of the herbicidal mixture of the present invention as described herein, thereby controlling the growth (e.g., killing the plant or a part thereof) of the plant that is contacted or that is growing in the plant environment that has been contacted with the herbicidal mixture. In some embodiments, the present invention provides a method of controlling undesirable plant growth comprising contacting an undesired plant and/or plant part thereof, and/or a plant environment with an effective amount of a composition comprising, consisting essentially of, or consisting of an acid and/or an ester and/or salt thereof (e.g., one or more C₈-C₁₀ fatty acids, one or more organic acids, a mixture of one or more C₈-C₁₀ fatty acids and one or more organic acids, and/or a salt and/or ester thereof) and an essential oil (e.g., eugenol and/or manuka oil), thereby controlling the growth (e.g., killing the plant or a part thereof) of the plant that is contacted or that is growing in the plant environment that has been contacted with the herbicidal mixture. In some embodiments, the herbicidal mixture (e.g., an effective amount of the herbicidal mixture) with the same amount or a lower amount of acid (e.g., a lower amount of C₈-C₁₀ fatty acids or organic acids (CH₃(CH₂)nCOOH, wherein n=6-8), or a lower amount of a mixture of one or more organic acids and one or more fatty acids) as compared to a standard herbicide comprising an acid (e.g., C₈-C₁₀ fatty acids or organic acids (CH₃(CH₂)nCOOH, wherein n=6-8) or mixture thereof, and/or a salt and/or ester thereof) but no essential oil (e.g., no eugenol and no manuka oil). In some embodiments, the herbicidal mixture of the invention for controlling undesirable plant growth and comprising acid (e.g., C₈-C₁₀ fatty acids or organic acids (CH₃(CH₂)nCOOH, wherein n=6-8) or mixture thereof, and/or a salt and/or ester thereof) and essential oil may comprise the same amount or may comprise at least about 25% to about 80% less acid than the amount of acid in an herbicide comprising acid and no essential oil (e.g., no eugenol oil and/or manuka oil)) and achieves the same or an increased herbicidal effect (is effective in controlling undesirable plant growth equally well or better than an herbicide comprising acid and no essential oil.

In some embodiments, a method of controlling plant growth and/or a method of controlling undesirable plant growth comprises contacting the plant and/or plant part thereof, the undesired plant and/or plant part thereof, and/or the plant environment at least one time (e.g., 1, 2, 3, 4, 5, 6, 7, or 8 or more times) or two or more times (e.g., 2, 3, 4, 5, 6, 7, or 8 or more times) with an effective amount of a composition of this invention.

The environment in which plant growth may be controlled using the herbicidal mixture of the invention may be any environment in which a plant may be growing and can include, for example, a residential yard, a landscaped area, a flower garden, a sidewalk or other walkway, a driveway, a street or road, a trail, a building or other structure (on which a plant may grow), a fence, trees, shrubs, a vacant lot, a wooded lot, a field, a plot, a plot under preparation as a garden or for crops, and the like.

As used herein, an “effective amount” of the herbicidal mixture means an amount of about 500 grams/hectare to about 1000 g/ha or about 1 kg/ha to about 25 kg/ha. In some embodiments, an effective amount is about 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 g/ha to about 1, 2, 3, 4, 5, 6, 7, 8, 9, 10, 11, 12, 13, 14, 15, 16, 17, 18, 19, 20, 21, 22, 23, 24, or 25 kg/ha or any amount or value therein. As would be understood, the amount applied may vary depending on what, if any, an additional active ingredient may be included in the herbicidal mixture or composition.

In some embodiments, an herbicidal mixture of the invention is applied to a plant, plant part or plant environment at a rate of about 2 gallons (gal) to about 4 gal per 1000 feet² (sq ft) (e.g., about 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 sq ft), or about 7.5 liters to about 15.5 liters per about 90 to about 95 meters² (M²) (e.g., about 7.5, 7.51, 7.52, 7.53, 7.54, 7.55, 7.56, 7.57, 7.58, 7.59, 7.6, 7.65, 7.7, 7.75, 7.8, 7.85, 7.9, 7.95, 8, 8.5, 9, 9.5, 10, 10.5, 11, 11.5, 12, 12.5, 13, 13.5, 14, 14.5, 15, 15.1, 15.12, 15.13, 15.14, 15.15, 15.16, 15.17, 15.18, 15.19, 15.2, 15.3, 15.4, 15.5 M² per about 90, 90.5, 91, 91.5, 92, 92.1, 92.2, 92.3, 92.4, 92.5, 92.6, 92.7, 92.8, 92.9, 93, 93.5, 94, 94.5, or 95 M²., optionally about 7.5 to about 15.5 liters per about 92.5 to about 93 M², or about 7.57 to about 15.14 liters per about 92.7 M².

When applied to plant environments, plants, and parts thereof, an herbicidal mixture of the invention achieves the same herbicidal effect or an increased herbicidal effect (e.g., killing the same type of weeds or additional weeds in the same time frame or more quickly with the same or an increased level of residual control) as compared to standard herbicidal mixtures comprising acid(s) but no essential oil. In some embodiments, the herbicidal mixture of the invention achieves the same herbicidal effect or an increased herbicidal effect as compared to standard herbicidal mixtures comprising acid(s) but no essential oil, wherein the herbicidal mixture of the invention comprises at least about 25% to about 80% less acid (e.g., about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% less than the standard herbicidal mixtures comprising fatty acids but no essential oil. Such standard herbicidal mixtures include, but are not limited to, Finalsan Weed and Grass (ammoniated soap of fatty acids (22% w/w)), Finalsan Plus Weed and Grass Killer (18.52% w/v pelargonic acid and 30 g/l (2.98% w/v) maleic hydrazide), SCYTHE (57% by wt pelargonic acid (Nonanoate) and related fatty acids (3% by wt), Axxe BIO Safe (ammonium nonanoate, 40% w/w), Mirimichi Green PRO Weed Control (ammonium nonanoate, 40.0 wt. %), Earth-Tone® 4 in 1 Weed Control (3.68% ammoniated soap of fatty acids and 0.5% maleic hydrazide, Natria™ Grass & Weed Killer (3.68% ammoniated soap of fatty acids and 0.5% maleic hydrazide). A standard herbicidal mixture for comparison to an organic acid mixture of this invention includes, but is not limited to, acetic acid, wherein the control comprises the same amount of acetic acid but without any essential oil.

In some embodiments, “controlling plant growth” or “controlling undesirable plant growth” includes residual control (e.g., control over time) of the growth of a plant or plant part. The residual control of plant growth is believed to be an effect of the combination of acid with the essential oil (e.g., the formulations of the invention). In some embodiments, residual control of the plant or plant part may be increased as compared to a control (e.g., the plant and/or plant part contacted with standard herbicidal compositions (e.g., an herbicide comprising acid but no essential oil). In some embodiments, the increase in residual control is an increase in control of plant growth over time. In some embodiments, control of plant growth may be increased by about 14, 15, 16, 17, 18, 19, 20, 21, 22, 23, 24 days (from the time of contact or application) as compared to a standard herbicidal mixture comprising acid but not essential oil. In some embodiments, the residual control by the herbicidal mixture of the invention used for “controlling plant growth” or “controlling undesirable plant growth” is increased by about 5%-40% (e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40%) over an herbicide comprising acid (e.g., one or more C₈-C₁₀ fatty acids, one or more organic acids, a mixture of one or more C₈-C₁₀ fatty acids and one or more organic acids, and/or a salt and/or ester thereof) and no essential oil (e.g., no eugenol oil and no manuka oil), or over about 14, 15, 16, 17, 18, 19, 20, 21, 22, 23, or 24 or more days from the time of contact or application.

Thus, in some embodiments, the present invention provides a method of providing residual control of a plant and/or plant part comprising contacting a plant, plant part, and/or a plant environment with an effective amount of a herbicidal mixture of the present invention as described herein. In some embodiments, the present invention provides a method of providing residual control of a plant and/or plant part comprising contacting a plant, plant part, and/or a plant environment with an effective amount of a composition comprising, consisting essentially of, or consisting of at least one acid (e.g., one or more C₈-C₁₀ fatty acids, one or more organic acids, a mixture of one or more C₈-C₁₀ fatty acids and one or more organic acids, and/or a salt and/or ester thereof) and at least one essential oil, as described herein.

The herbicide mixture or composition of the invention may be used to reduce/suppress the growth of most herbaceous plants, including most weeds.

In some embodiments, a plant or plant part thereof for which an herbicidal mixture or composition of the invention may be used to reduce/suppress the growth may be, for example, any herbaceous plant (e.g., a plant or part thereof having little or no woody tissue). In some embodiments, a plant or plant part thereof for which an herbicidal mixture or composition of the invention may be used to reduce/suppress the growth may be an angiosperm (e.g., a dicot plant or a monocot plant), gymnosperm, an algae, a bryophyte (e.g., a moss), fern and/or fern ally (i.e., pteridophyte). In some embodiments, a plant and/or plant part for which the herbicide mixture of this invention controls growth may be a dicot (broadleaf) plant or a monocot plant, or part thereof. A non-limiting example of a monocot may be a grass. Further non-limiting examples of a plant, or plant part thereof, for which control of growth may be desirable using an herbicidal mixture of the invention can include grasses, mosses, and algae. In some embodiments, a plant or part thereof can include, but is not limited to, annual bluegrass, barnyardgrass, black medick, broadleaf fillaree, broom, burclover, cat's-ear, common chickweed, common groundsel, common lamb's-quarters, corn spurry, creeping buttercup, curled dock, dandelion, English daisy, false dandelion, fiddleneck, fleabane, foxtail fescue, geranium species, horsetail, kudzu, large crabgrass, lady's-thumb, locoweed, low cudweed, lupine, mouse-eared chickweed, mustard species, oxalis, plantain species, poison ivy, poison oak, red clover, redroot pigweed, round leaved mallow, rush, sheep sorrel, shepherd's-purse, spiny annual sowthistle, stinkweed, wild blackberry, wild carrot, wild hyacinth and/or white clover. In some embodiments, a plant or part thereof that is controlled by the herbicidal mixtures of the invention can include turfgrasses, which can include, but is not limited to, Kentucky bluegrass, perennial ryegrass, bentgrass, tall fescue, fine fescue, Bermuda grass, St. Augustine grass, zoysia grass, bahaigrass, buffalograss, carpetgrass, centipede grass, kikuyu grass, seashore paspalam, or any combination thereof (e.g., a combination of two or more different types of turfgrasses).

The invention will now be described with reference to the following examples. It should be appreciated that these examples are not intended to limit the scope of the claims to the invention but are rather intended to be exemplary of certain embodiments. Any variations in the exemplified methods that occur to the skilled artisan are intended to fall within the scope of the invention.

### EXAMPLES

### Example 1. Comparison of Weed Control by Various Fatty Acid and/or Essential Oil Formulations

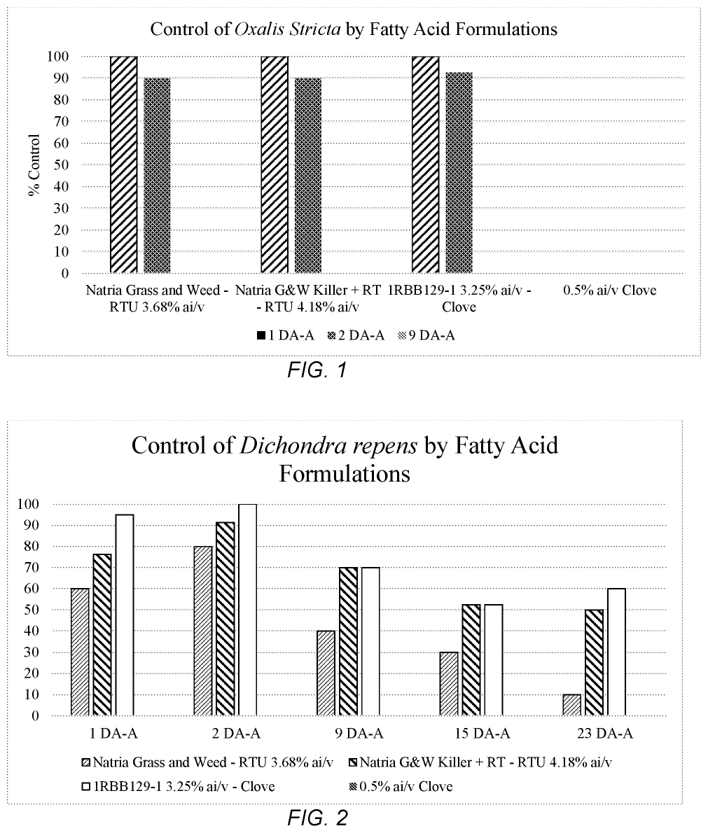

Various known herbicides and the new herbicidal mixtures of the present invention were applied to different weeds (FIGS. 1-7). Specifically, FIG. 1 shows the results of a field trial comparing the control of Oxalis stricta using an example of the new formulation (1RBB129-1 (fatty acid at 2.75% and clove oil at 0.5% ai/v)) to that of Natria Grass and Weed (3.68% fatty acid ai/v) and Natria G&W Killer+Root Kill (3.68% fatty acid+0.5% maleic acid ai/v). Applications were made directly to the plant and sprayed until first drip. The results showing fatty acid with clove at all the concentrations tested were equal to or greater than fatty acid on its own or fatty acid with maleic hydrazide.

A field trial was carried out comparing the control of Dichondra repens using an example of the new formulation (1RBB129-1 (fatty acid at 2.75% and clove at 0.5% ai/v)) to that of Natria Grass and Weed (3.68% fatty acid ai/v) and Natria G&W Killer+Root Kill (3.68% fatty acid+0.5% maleic acid ai/v). Applications were made directly to the plant and sprayed until first drip. The results are provided in FIG. 2 which show that fatty acid with clove at all the concentrations tested were equal to or better than fatty acid on its own or fatty acid with maleic hydrazide.

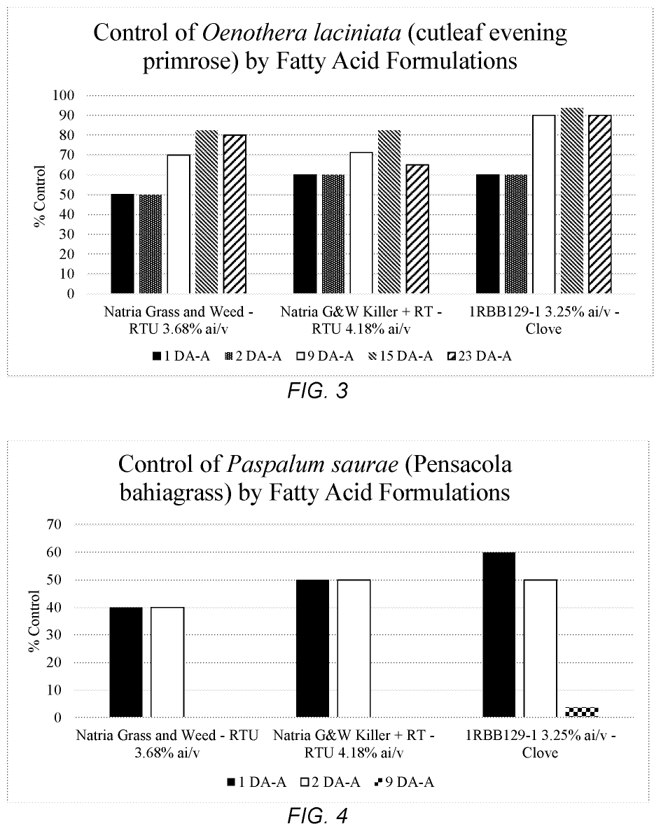

FIG. 3 shows the results of a field trial comparing the control of Oenothera laciniata by several formulations of fatty acid (Natria Grass and Weed 3.68% fatty acid ai/v, Natria G&W Killer+RT 3.68% fatty acid+0.5% maleic acid ai/v) with that of an example of the new formulation (1RBB129-1 (2.75% fatty acid+0.5% clove oil ai/v)). Applications were made directly to the plant and sprayed until first drip. The results showing fatty acid with clove at the concentrations tested were equal to or better than fatty acid on its own or fatty acid with maleic hydrazide.

A field trial was carried out to compare the control of Paspalum saurae by several fatty acid formulations (Natria Grass and Weed 3.68% fatty acid ai/v, Natria G&W Killer+RT 3.68% fatty acid+0.5% maleic acid ai/v) with that of an example of the new formulation (1RBB129-1 (2.75% fatty acid+0.5% clove oil ai/v)) Applications were made directly to the plant and sprayed until first drip. The results are provided in FIG. 4, which shows that fatty acid with clove at the concentrations tested were equal to or better than fatty acid on its own or fatty acid with maleic hydrazide.

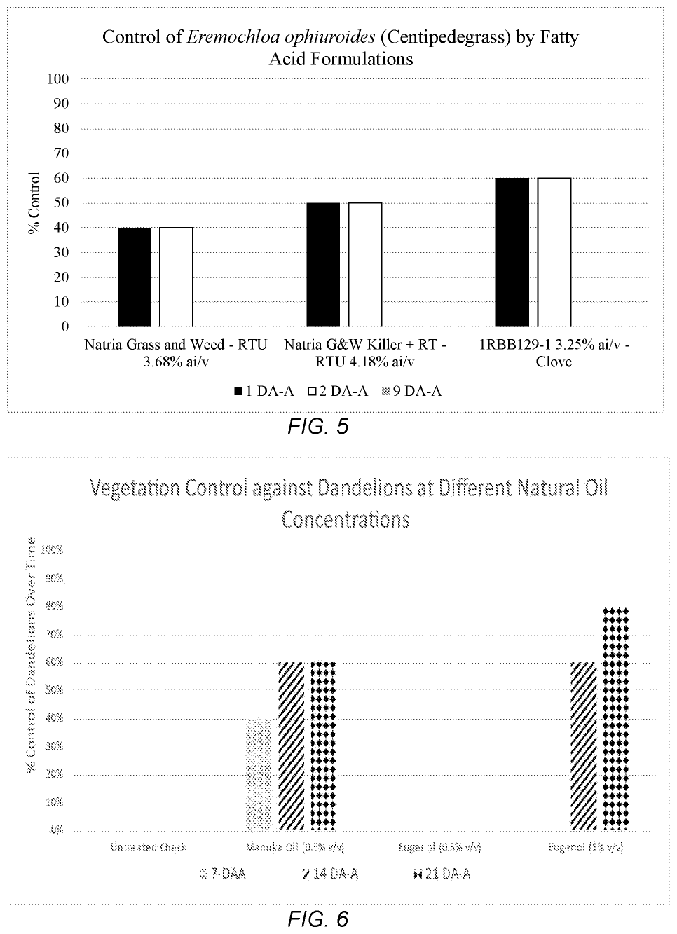

FIG. 5 shows the results of a field trial comparing the control of Eremochloa ophiuroides by several fatty acid formulations (Natria Grass and Weed 3.68% fatty acid ai/v, Natria G&W Killer+RT 3.68% fatty acid+0.5% maleic acid ai/v) with that of an example of the new formulation (1RBB129-1 (2.75% fatty acid+0.5% clove oil ai/v)). Applications were made directly to the plant and sprayed until first drip. The results showing fatty acid with clove at the concentrations tested were equal to or better than fatty acid on its own or fatty acid with maleic hydrazide.

The effect of fatty acid, fatty acid+clove oil, and fatty acid with maleic acid on dandelion regrowth was studied. Applications were made directly to the plant and sprayed until first drip. The results are shown in Table 1 and FIG. 6.

TABLE 1
Dandelion regrowth following application of
various herbicides and herbicidal mixtures.

| | Percent Regrowth | | | | |
|---|---|---|---|---|---|
| | 1 DAT | 2 DAT | 7 DAT | 14 DAT | 21 DAT |
| UTC | 100% | 100% | 100% | 100% | 100% |
| Natria Grass and Weed | 0% | 0% | 0% | 50% | 50% |
| Natria G&W Killer + RT | 0% | 0% | 0% | 33% | 50% |
| (Nan. Acid 3.68% + | | | | | |
| Maleic hydrazide | | | | | |
| 0.5 ai/v) | | | | | |
| Nan. Acid* + Clove oil | 0% | 0% | 0% | 0% | 0% |
| (3.68% + 5% ai/v) | | | | | |
| Nan. Acid + Clove oil | 0% | 0% | 0% | 0% | 0% |
| (3.68% + 1.04% ai/v) | | | | | |
| Nan. Acid + Clove oil | 0% | 0% | 0% | 0% | 0% |
| (3.68% + 0.81% ai/v) | | | | | |
| Nan. Acid + Clove oil | 0% | 0% | 0% | 0% | 0% |
| (3.68% + 0.61% ai/v) | | | | | |
| Nan. Acid + Clove oil | 0% | 0% | 0% | 17% | 17% |
| (3.68% + 0.41% ai/v) | | | | | |
| Clove oil 0.5% | 100% | 100% | 100% | 100% | 100% |

*Nan. Acid″ = nine chain fatty acid; UTC = untreated control; DAT = days after treatment

The results show that fatty acid with clove at all the concentrations tested were equal to or better than fatty acid on its own or with fatty acid with maleic hydrazide. FIG. 6 shows the results of a greenhouse trial comparing dandelion regrowth after an application of various natural oils. Results show no effect of straight clove oil and regrowth of dandelions after 14 days from straight fatty acid application.

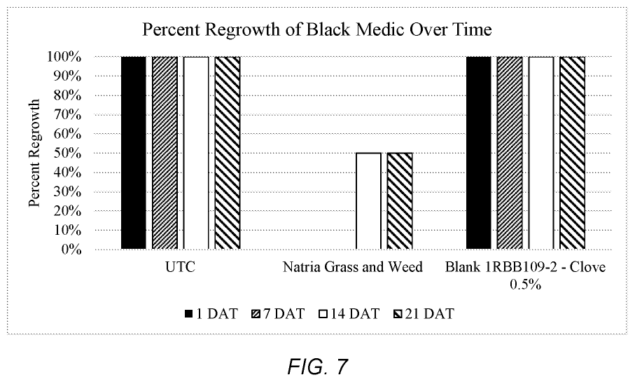

FIG. 7 shows the results of a greenhouse trial comparing black medic regrowth after an application of Natria Grass and Weed (3.685 fatty acid ai/v) or strait clove oil at 0.5%. Applications were made directly to the plant and sprayed until first drip. Results show no effect of straight clove oil and regrowth of black medic after 14 days from straight fatty acid application.

A field trial was carried out to compare the control of Euphorbia sp. by several fatty acid formulations. The results are provided in Table 2. Applications were made directly to the plant and sprayed until first drip. Numbers with the different letters in the same column are significantly different (p>0.05)

TABLE 2
Field trial comparing the control of Euphorbia sp. by several fatty acid formulations.

| | % Control | | | | | | | | | |
|---|---|---|---|---|---|---|---|---|---|---|
| Treatment | 0 DA-A | | 1 DA-A | | 3 DA-A | | 7 DA-A | | 14 DA-A | |
| Untreated Check | 95 | — | 0 | b | 0 | c | 0 | d | 0 | c |
| Natria Grass and Weed - | 95 | — | 75 | a | 86.7 | b | 70 | c | 61.7 | b |
| (3.68% fatty acid ai/v) | | | | | | | | | | |
| Natria G&W Killer + RT (3.68% | 95 | — | 75 | a | 84 | b | 71.7 | bc | 66.7 | ab |
| fatty acid + 0.5% maelic | | | | | | | | | | |
| hydrazide ai/v) | | | | | | | | | | |
| 1RBB129-1 (2.75% fatty acid + | 95 | — | 75 | a | 95 | a | 78.3 | ab | 76.7 | a |
| 0.5% clove oil ai/v) | | | | | | | | | | |
| 1RBB129-30 (2.75% fatty acid + | 95 | — | 75 | a | 94 | a | 80 | a | 75 | a |
| 0.5% eugenol oil ai/v) | | | | | | | | | | |

The results shows that by 3 days after application, the herbicidal mixtures of the present invention performed better than formulations comprising fatty acid only or fatty acid with maleic hydrazide.

The foregoing is illustrative of the present invention and is not to be construed as limiting thereof. The invention is defined by the following claims, with equivalents of the claims to be included therein.

That which is claimed is:

1. An herbicidal mixture comprising:
an acid and/or a salt and/or an ester of an acid; and
an essential oil, wherein the acid is a fatty acid and/or an organic acid.

2. The herbicidal mixture of claim 1, wherein the organic acid comprises the formula of C₂H₂ₙO₂.

3. The herbicidal mixture of claim 2, wherein the acid is an organic acid is formic acid, acetic acid, propionic acid, butyric acid (butanoic acid), valeric acid, hexanoic acid, heptanoic acid, octanoic acid (caprylic acid), and/or nonanoic acid.

4. The herbicidal mixture of claim 2, wherein the fatty acid is a saturated fatty acid comprising the formula of CH₃(CH₂)nCOOH, wherein n=6-8.

5. The herbicidal mixture of claim 3, wherein the saturated fatty acid is a C₈ fatty acid (caprylic acid (octanoic acid)), a C₉ fatty acid (pelargonic acid (nonanoic acid)), a C₁₀ fatty acid (capric acid (decanoic acid)), or any combination thereof.

6. The herbicidal mixture of any one of claims 1-5, wherein the essential oil is eugenol (i.e., oil of clove), manuka oil, wormwood oil, cinnamon oil, nutmeg oil, basil oil, Japanese star anise oil, lemon balm oil, dill oil, pimenta racemose oil, vanilla oil, bay laurel oil, celery oil, ginger oil, wood avens oil, or any combination thereof.

7. The herbicidal mixture of any one of claims 1-5, wherein the essential oil comprises eugenol.

8. The herbicidal mixture of any one of claims 1-5 and 7, wherein the essential oil comprises manuka oil.

9. The herbicidal mixture of any one of the preceding claims, wherein the acid and essential oil are present in a ratio of about 0.15 to about 30, optionally about 1 to about 10 or about 4 to about 6, optionally about 5.5.

10. The herbicidal mixture of any one of the preceding claims, wherein the acid is present in an amount of about 1% to about 4% weight/volume (w/v) of the herbicidal mixture, optionally about 1.25% to about 3%.

11. The herbicidal mixture of any one of the preceding claims, wherein the essential oil is present in an amount of about 0.1% to about 8% (w/v) of the herbicidal mixture.

12. The herbicidal mixture of any one of the preceding claims, wherein the acid is present in an amount of about 2% to about 3% and the essential oil is present in an amount of about 0.2% to about 1%.

13. The herbicidal mixture of any one of the preceding claims, wherein the acid is present in an amount of about 2.75% and the essential oil is present in an amount of about 0.5%.

14. The herbicidal mixture of any one of claims 1-8, wherein the herbicidal mixture is a concentrate and the acid is present in an amount of about 10% to about 25% and the essential oil is present in an amount of about 1% to about 15%, optionally about 20-25% acid and about 3-5% essential oil.

15. The herbicidal mixture any one of claims 1-14, wherein the herbicidal mixture is in the form of a liquid or a solid (e.g., a spray, aqueous solution, a non-aqueous solution, a suspension, an emulsion (e.g., in oil (vegetable or mineral)), a flowable mixture, a slurry, a powder, a particle, a granule, a mist, an aerosol, a foam, and any combination thereof.

16. The herbicidal mixture of any one of claims 1-15, wherein the mixture further comprises an additional active ingredient, optionally in an amount of about 0.02 w/v to 25% w/v of the herbicidal mixture.

17. The herbicidal mixture of claim 16, wherein the additional active ingredient is a pre-emergent herbicide or a post-emergent herbicide.

18. The herbicidal mixture of claim 17, wherein the post-emergent herbicide is a post-emergent broadleaf herbicide, a post-emergent crabgrass herbicide and/or a post-emergent grass herbicide.

19. The herbicidal mixture of claim 17, wherein the pre-emergent herbicide is atrazine, benefin, bensulide, DCPA, dimethenamid, ethofumesate, florasulam, flumioxazin, indaziflam, isoxaben, metolachlor, oryzalin, oxadiazon, pendimethalin, prodiamine, pronamide, siduron, maleic hydrazide, and/or simazine.

20. The herbicidal mixture of claim 18, wherein the post-emergent broadleaf herbicide is 2,4-DP, amicarbazone, atrazine, bentazon, bispyribac-sodium, bromoxynil, carfentrazone, chlorsulfuron, clopyralid, ethofumesate, flazasulfuron, florasulam, fluroxypyr, glyphosate, halosulfuron, imazapic, imazaquin, imazasulfuron, MCPA, mesitrione, metribuzin, metsulfuron, MSMA, penoxsulam, pyraflufen-ethyl, quinclorac, quinclorac, simazine, sulfentrazone, sulfosulfuron, thiencarbacone, thiencarbazone, topramezone, triclopyr, maleic hydrazide, and/or trifloxysulfuron.

21. The herbicidal mixture of claim 18, wherein the post-emergent crabgrass herbicide is atrazine, auslam, bispyribac-sodium, fenoxaprop, fluorasulam, MSMA, quinclorac, maleic hydrazide, and/or simazine.

22. The herbicidal mixture of claim 18, wherein the post-emergent grass herbicide is bentazon, carfentrazone, chlorsulfuron, clethodim, diflufenzopyr, diquat, fenoxaprop, flazasulfuron, fluazifop, fluoxapyr, foramsulfuron, glufosinate, glyphosate, halosulfuron, imazapyr, imazaquin, imazapic, imazethapyr, indaziflam, iodosulfuron, mesotrione, metribuzin, metsulfuron, MSMA, paraquat, pronamide, quinclorac, risulfuron, sethoxydim, sulfentrazone, topramezone, maleic hydrazide, and/or trilopyr.

23. A method of controlling plant growth comprising contacting a plant, plant part, and/or plant environment with an effective amount of the herbicidal mixture of any one of claims 1 to 22.

24. The method of claim 23, wherein the herbicidal mixture achieves an increased herbicidal effect as compared to a standard herbicide comprising an acid (e.g., one or more C₈-C₁₀ fatty acids, one or more organic acids (CH₃(CH₂)nCOOH, wherein n=6-8), or a mixture of one or more organic acids and one or more fatty acids and/or salts and/or esters thereof) but no essential oil (e.g., no eugenol and no manuka oil).

25. The method of claim 23, wherein the herbicidal mixture achieves the same or an increased herbicidal effect with a lower amount of an acid (e.g., a lower amount of one or more C₈-C₁₀ fatty acids, one or more organic acids (CH₃(CH₂)nCOOH, wherein n=6-8), or a a mixture of one or more organic acids and one or more fatty acids, and/or salts and/or esters thereof) as compared to a standard herbicide comprising an acid but no essential oil (e.g., no eugenol and no manuka oil).

26. The method of claim 25, wherein the herbicidal mixture comprises at least about 25% to about 80% less acid than the amount in a standard herbicide comprising an acid and no essential oil.

27. The method of any one of claims 23-26, wherein the herbicidal mixture is applied to a plant, plant part or plant environment at a rate of about 2 gallons (gal) to about 4 gal per 1000 square feet (sq ft) or about 7.5 liters to about 15.5 liters per about 90 to 95 square meters (m²).

28. The method of any one of claims 23-27, wherein controlling plant growth includes residual control (e.g., control over time) of the growth of the plant or plant part.

29. The method of claim 28, wherein the residual control by the herbicidal mixture is increased by about 5%-40% over an herbicide comprising an acid (e.g., one or more C₈-C₁₀ fatty acids, one or more organic acids (CH₃(CH₂)nCOOH, wherein n=6-8), or a mixture of one or more organic acids and one or more fatty acids and/or salts and/or esters thereof) and no essential oil.

30. The method of any one of claims 23-29, wherein the plant and/or plant part thereof is an herbaceous plant.

31. The method of any one of claims 23-29, wherein the plant and/or plant part thereof is an angiosperm (e.g., a dicot plant or a monocot plant), gymnosperm, an algae, a bryophyte (e.g., a moss), fern and/or fern ally (i.e., pteridophyte).
